(19) United States
(12) Patent Application Publication
(10) Pub. No.: US 2010/0010643 A1
(43) Pub. Date: Jan. 14, 2010

(54) Method and system for controlling a usage of an object

(75) Inventors: Itzhak Pomerantz, Kfar Saba (IL); Itzhak Binyamini, Ramat Hasharon (IL)

Correspondence Address: Pearl Cohen Zedek Latzer, LLP, 1500 Broadway, 12th Floor, New York, NY, 10036, US

(73) Assignee: Afeka Academic, Tel Aviv (IL)

(21) Appl. No.: 12/172,235

(22) Filed: Jul. 13, 2008

(51) Int. Cl. G05B 15/02

(52) U.S. Cl. 700/22

(57) ABSTRACT

A system and method for controlling a usage of objects, the method includes: receiving, by a control unit, an indication that a user intends to use an object; wherein the utilization is dependent upon a reception of power from a power supply network; receiving, by the control unit, over a power line communication network and from a power controller associated with the object, a request to determine whether to enable a provision of power from the power supply network; determining, by the control unit, whether to allow a reception of power by the object; and sending to the power controller a power indication representative of the determination.

### FIELD OF THE INVENTION

The invention relates to methods and systems for controlling a usage of an object.

### BACKGROUND OF THE INVENTION

Objects, including costly electrical equipment, power consuming devices, devices that do not consume electrical power and the like, can be used, at any given point of time, by a user out of multiple users, within a predefined premise such as a factory, a business building, and the like. Object can get lost, get stolen, be utilized in an insufficient manner or utilized by unauthorized users.

There is a need to provide an efficient system and method for controlling the usage of objects.

### SUMMARY OF THE INVENTION

A method for controlling a usage of objects, the method includes: receiving, by a control unit, an indication that a user intends to use an object; wherein the utilization is dependent upon a reception of power from a power supply network; receiving, by the control unit, over a power line communication network and from a power controller associated with the object, a request to determine whether to enable a provision of power from the power supply network; determining, by the control unit, whether to allow a reception of power by the object; and sending to the power controller a power indication representative of the determination.

A system for controlling a usage of objects, the system includes: a control unit that includes: a storage unit adapted to store an indication that a user intends to use an object; wherein the utilization is dependent upon a reception of power from a power supply network; a power line communication receiver, adapted to receive, over a power line communication network and from a power controller associated with the object, a request to determine whether to enable a provision of power from the power supply network; a controller, adapted to determine whether to allow a reception of power by the object; and a power line communication transmitter, adapted to send to the power controller a power indication representative of the determination.

A device comprising: a power controller, a relay, and power line communication transceiver; wherein the relay is coupled between a power supply network and an object and is controlled by the power controller; wherein the power controller controls the relay in response to a power indication that was generated by a control unit that is coupled to the power line communication transceiver over the power supply network; wherein the power indication is sent in response to an indication that a user intends to use the object; and wherein the utilization is dependent upon a reception of power from the power supply network.

### BRIEF DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views, in which:

FIG. 1 illustrates a system according to an embodiment of the invention;

FIG. 2 illustrates a power controller according to an embodiment of the invention;

FIG. 3 illustrates a power controller according to an embodiment of the invention;

FIG. 4 illustrates a method for controlling a usage of objects, according to an embodiment of the invention;

FIG. 5 illustrates a method for controlling a usage of objects, according to an embodiment of the invention;

FIG. 6 illustrates a method detecting an absence of an object, according to an embodiment of the invention; and

FIG. 7 illustrates a control unit and its environment according to an embodiment of the invention.

### DETAILED DESCRIPTION OF THE DRAWINGS

A method and system for controlling a usage of an object are provided. Instead of using inefficient manual methods of manually filling forms to determine the transfer of ownership of objects from user to another, an automated, highly efficient method and system are provided. In order to simplify the implementation of such a system and method the existing power supply network is used in order to convey information between a central control unit and multiple power controllers. A power line communication (PLC) network is established over the power supply network. PLC communication circuits are included within or connected to power controllers and can be included in a control unit. An object can be associated with a power controller that is configured to allow a provision of power to the object only after it receives an approval from the control unit and over the PLC network, to do so. The approval is generated by the control unit.

The method and system allows to efficiently track objects and to control their usage by users. An object can receive power from the power supply network only after the control unit logs the current user of the object as the object “owner”.

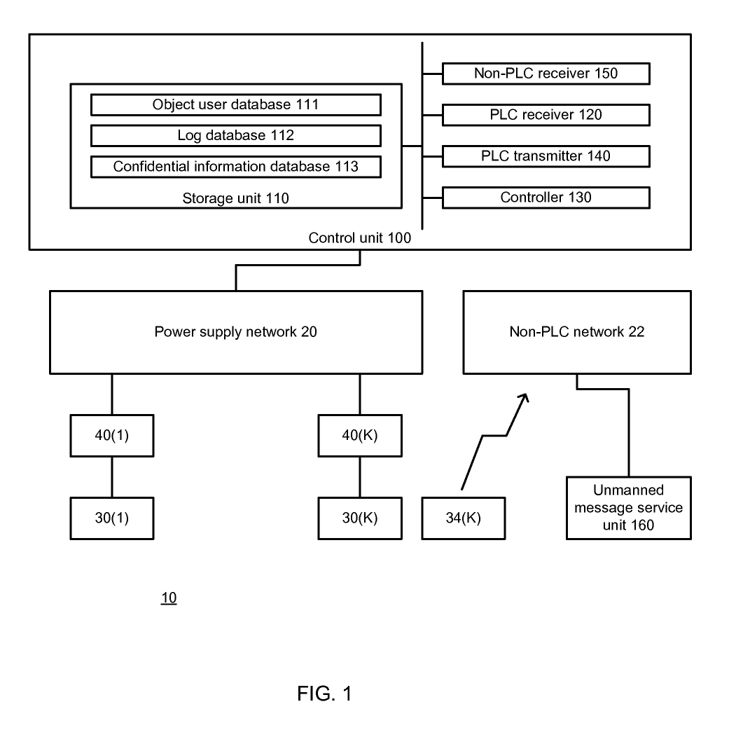

FIG. 1 illustrates system 10 according to an embodiment of the invention.

System 10 includes control unit 100. It can also include multiple power controllers 40(1)-40(k) that are connected to control unit 100 via power line communication (PCL) network that is implemented over a power supply network 20. PLC network can be the power supply network itself or can include additional components such as PLC receivers, PLC transmitter and the like. It is assumed that PLC network is the power supply network 20. Control unit 100 can include one or more servers, one or more computers, and the like. It can be located at a remote site or near the objects. Typically, control unit 100 can be accessed within a predefined premise, via PLC network 20.

Control unit 100 includes storage unit 110, PLC receiver 120, controller 130, PLC transmitter 140, and non-PLC receiver 150. Many manufacturers of PLC equipment are known. For example, VIPA art of automation, Amperion Inc., Broadband Horizons, Corinex, Current Technologies, devolo, DS2, Dimat, Dimonoff, Mitsubishi, Fiberbridge, InovaTech EMEA, Intellon, PowerNet Communications, Panasonic, RFL Electronics, Thomson SA, Xeline Ltd, PowerNet Ltd and Delta PLC.

Control unit 100 can monitor an object usage by receiving information relating to a characteristic of a power consumption of the object. The characteristic can be amount of power consumption, duration of power consumption, profile of power consumption (including changes over time of power consumption) and the like.

A power controller out of 40(1)-40(k) can be embedded in a power cord that is connected in a non-detachable manner to the object.

Alternatively, the power controller can be embedded in the object. Yet alternatively, the power controller can be embedded in an object that is mechanically connected to another object. The other object can consume electrical power or not consume electrical power. The connectivity between the object to the other object facilitates a monitoring after the other object. The object can be mechanically connected to the other object in a manner that prevents (or at least complicates) these object and other object from being separated from each other. The object can grip the other object, can surround the other object, and the like.

Storage unit 110 is adapted to store a request from a user to utilize an object, wherein the utilization is dependent upon a connection of the object to the power network. The request can be received by non-PLC receiver 150. Storage unit 110 can store additional information such as but not limited to: (i) object user database 111 that indicates which users are currently allowed to utilize objects; (ii) log database 112 that includes information of previous usages of objects; (iii) conditional information database 113 that includes information indicative of at least one of the following: (a) by which users the object can be utilized; (b) when the object can be utilized; (c) at which location the object can be utilized; (d) whether the object can exit a predetermined premises, or a combination thereof.

It is noted that some of the mentioned above databases can be stored (at least partially) at another storage unit that can be accessed by controller 130.

Controller 130 is adapted to determine whether to allow connection of an object to the power supply network by the power controller. The determination can be responsive to the content of any of the mentioned above databases.

Once the determination is made controller 130 can send an indication to the relevant power controller, via PLC transmitter. If controller 130 determines that the user should be allowed to utilize the object then it can update object user database 111.

PLC receiver 120 and PLC transmitter 140 can be integrated to provide a PCL modem. They facilitate an exchange of signals over PLC network 20 with power controllers 40(1)-40(k).

PLC receiver 120 can receive, over a power line communication network and from a power controller associated with the object, a request to determine whether to enable a connection of the object to the power supply network.

PLC transmitter 140 can send to a requesting power controller a power indication representative of the determination of controller 130.

Non-PLC receiver 150 can receive the request from a user via non-PLC network 22 that differs from PLC network 20. Non-PLC network 22 can be a wireless network, a wired communication network, and the like. The request can be sent to an unmanned message service unit 160 that receives and records a voice (or text) message from the user and sends information representative of this message to non-PLC receiver. Thus, the user can be requested to dial to a predetermined number (of the unmanned message service unit 160) and enter a user identifier and an object identifier. If these identifiers are entered, using voice then unmanned service unit 160 can convert these identifiers to text, using voice recognition techniques. These identifiers can also be entered by using SMS messages or other textual manners that do not require voice recognition analysis. FIG. 1 illustrates user 33(k) of object 30(k) as connecting to unmanned service unit 160 by his mobile phone 34(k).

Conveniently, power controllers 40(1) can transmit to control unit 100 information indicative of the power consumption of the object. Processor 130 can process this information (for example by comparing it against expected power consumption information) and determine whether the power consumption is within acceptable limits. It is noted that other determination can be made. For example, a report indicative of the power consumption of one or more objects can be made and sent to a user, or to an administrator. This information can also be stored in storage unit 110.

Typically, PLC network 20 is not able to indicate the location of objects. Accordingly, control unit 110 is not aware of the location of objects. In order to provide location information various techniques can be applied. The location information improves the monitoring after objects and their usages. Location information can be transmitted over PCL network 20, and additionally or alternatively over non-PLC network 22. Control unit 100 can, for example, decline to connect an object to the power supply network if the object is located outside a permitted area.

For example, each power outlet can be associated with a unique identifier. The unique identifier can be sensed by a power controller that is connected to this power outlet and is then sent, over PLC network 20 to control unit 110. This can be achieved by applying various well-known short-range communication techniques such as RFID based communication.

Yet for another example, the power controller can be associated with a unique identifier. The unique identifier can be sensed by transceivers that are positioned in predefined locations. Once a transceiver senses that unique identifier it transmits it over non-PLC network 22.

Yet for a further example, the location can be determined based upon triangulation or global positioning system based techniques. These techniques utilize a receiver that is connected to the object or to control unit 100

According to an embodiment of the invention control unit 100 can apply one policy when the object is inside a predefined premises and another when the object is outside the predefined premises. For example, the object cannot be allowed to exit the predefined premises. Yet for another example, the object can be allowed to exit the predefined premises only if one or more conditions are fulfilled. Such a condition can include an authorization to exit the predefined premises. The authorization can be issued only by predefined persons (for example, managers, object administrator, logistics department employees).

Conveniently, once an object arrives to an exit of a predefined premises an exit indication can be sent to control unit 100. A guard (or another person or even an unmanned sensor) can indicate that the object arrived to an exit point. This indication can require the guard to contact unmanned message service unit 160 or contact control unit 100. This indication can resemble a request from a user to utilize an object but includes an indication that the request is an exit request. The indication can be the identity of the guard. The exit can include a unique identifier element (such as an RFID tag) that can be sensed by power controller that will send, via PLC network, an exit indication to control unit 100.

It is noted that a power controller and its associated object can exchange information.

Control unit 100, in response to the reception of the exit indication, can allow the object to exit the predefined premises, can generate an exit forbidding indication, or can prevent the object from being connected to the power supply network.

It is assumed that once the object leaves the predefined premises it cannot communicate via PLC network 20 with control unit 100. Accordingly, in order to allow the object to be utilized outside the predefined premises control unit 100 should instruct the power controller of that object to connect enable the object to receive power in an unconditional manner when the object is located outside a predefined premises and if the object is allowed to exit the predefined premises. Unless such an instruction is received the object cannot be utilizes as its power controller will not receive an approval to connect the object to a power supply network.

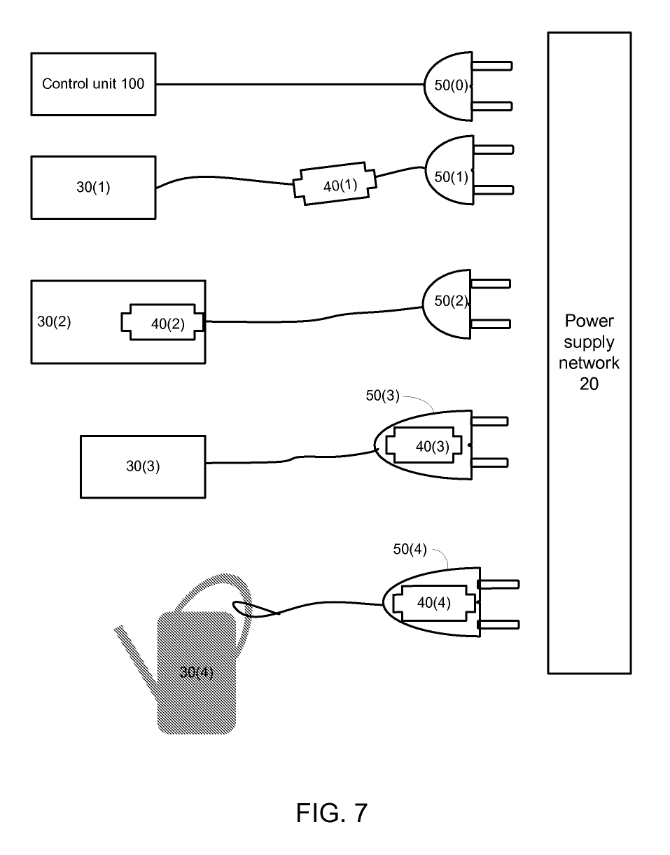

FIG. 7 illustrates control unit 100 and its environment according to an embodiment of the invention.

Control unit 100 (and especially an interface of control unit 100) is connected via plug 50(0) to power supply network 20.

Device 30(1) is connected via a cable to power controller 40(1) that is connected via that cable to plug 50(1). Power controller 40(1) is included within an interface that is connected to the cable. Plug 50(1) can be connected to power supply network 20.

Device 30(2) includes power controller 40(2). It is connected via a cable to plug 50(2).

Device 30(3) is connected to a modified plug 50(3) that includes power controller 40(3).

Object 30(4) is connected to a leash that is connected to a modified plug 50(4) that includes power controller 40(3). Object 30(4) can be an object that does not require power supply for its operation.

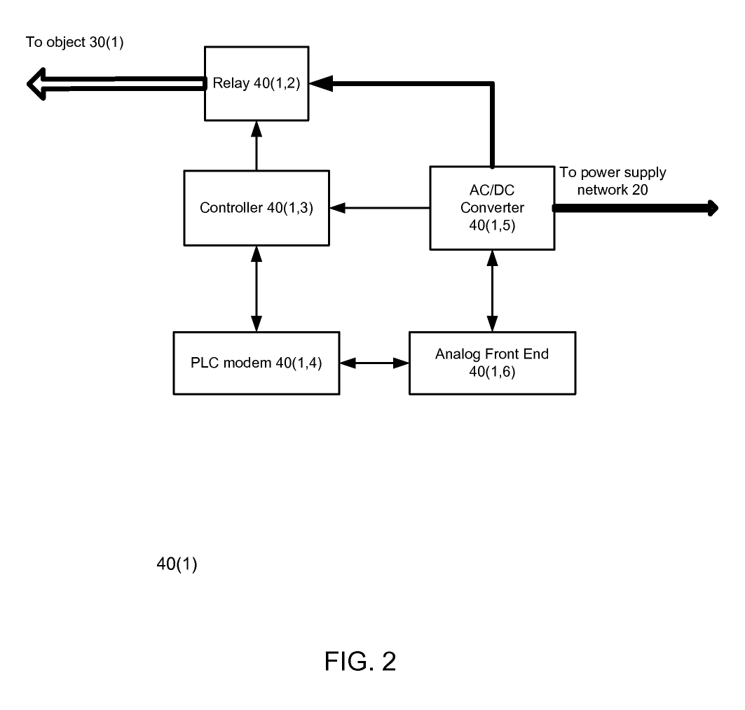

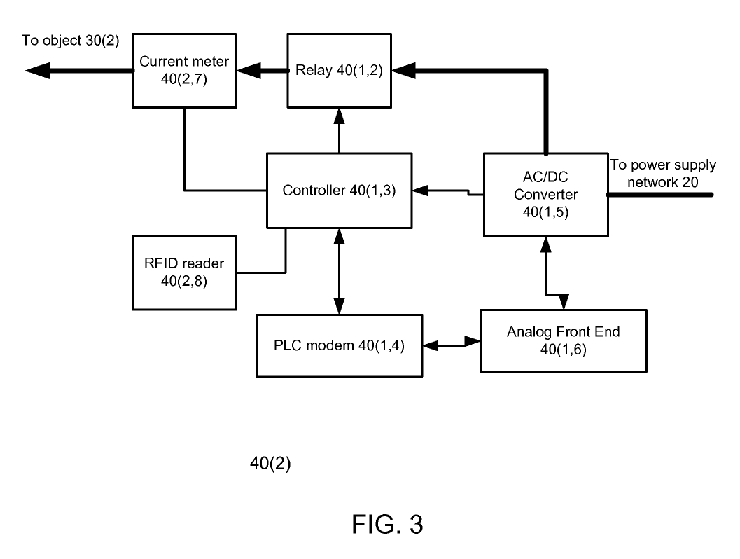

It is noted that each of the mentioned above power controllers can be a power controller of FIG. 2 or a power controller of FIG. 3.

FIG. 2 illustrates power controller 40(1) according to an embodiment of the invention.

Power controller 40(1) can connect object 30(1) to a power supply network. It can be integrated within object 30(1), or can be connected between object 30(1) to a power outlet 50(1) of the power supply network. In the latter case it should be connected in a manner that complicates (or even prevents) it from being bypassed.

For example, power controller 40(1) can be integrated with a power cord that is non-detachable connected to object 30(1).

Yet according to an embodiment of the invention power controller 40(1) can be integrated with a detachable power cord that is connected by mechanical means to object 30(1) in a manner that complicates (or even prevents) the detachable cord from being disconnected from object 30(1).

Yet according to another embodiment of the invention, the object does not require to receive power in order to be utilized. It is rather physically connected to an intermediate object. The intermediate object includes the power controller.

Power controller 40(1) includes relay 40(1,2), controller 40(1,3), PLC modem 40(1,4), AC/DC converter 40(1,5), and analog front end 40(1,6).

AC/DC converter 40(1,5) is connected to a power supply network via an outlet or an inlet. It provides high level AC voltage to relay 40(1,2) that once closed provides this high level AC voltage to object 30(1,1). Relay 40(1,2) is controlled by controller 40(1,3).

AC/DC converter 40(1,5) also supplies low level DC voltage to the other components of power controller 40(1,1).

PLC modem 40(1,4) communicates with the PLC network via analog front end 40(1,6).

Controller 40(1,3) can receive and transmit information by communicating with PLC modem 40(1,4). It can, in response to a power indication received from PLC modem 40(1,4) instruct relay 40(1,2) to provide power to object 30(1).

FIG. 3 illustrates power controller 40(2) according to an embodiment of the invention.

Power controller 40(2) differs from power controller 40(1) by including current meter 40(2,7) and RFID reader 40(2,8). It can include only one of these additional components.

Current meter 40(2,7) can read the current drained by object 30(2) and provide the information that once processed can indicate what is the power consumption of object 30(2).

RFID reader 40(2,8) can read a unique identifier associated (by a RFID tag) with a power inlet or a power outlet o which power controller 40(2) is connected and transmit, over PCL network, this information to the control unit.

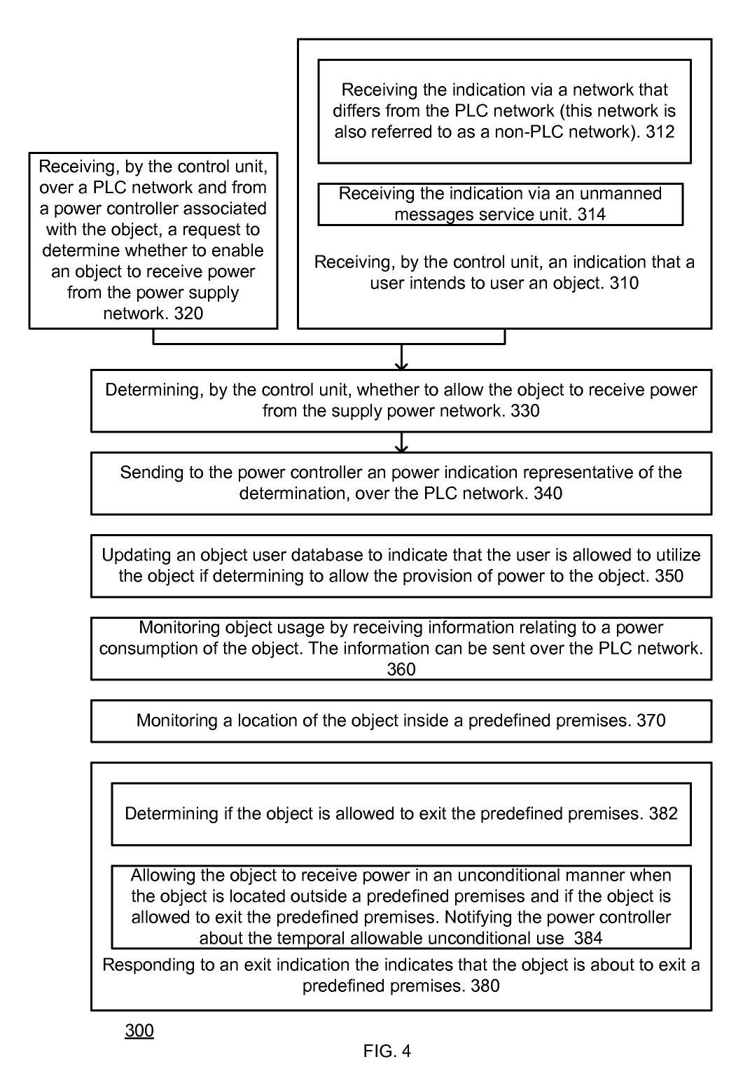

FIG. 4 illustrates method 300 for controlling a usage of objects, according to an embodiment of the invention.

Method 300 is executed by a system such as control unit 100.

Method 300 starts by stages 310 and 320.

Stage 310 includes receiving, by a control unit, an indication that a user intends to use an object; wherein the utilization is dependent upon a reception of power from a power supply network.

Stage 310 can include stage 312 of receiving the indication (which can be a user request) from a user via a network that differs from the PLC network (this network is also referred to as a non-PLC network).

Stage 310 can include stage 314 of receiving the indication from a user via an unmanned messages service unit that can be an Indirect Voice Response unit.

Stage 310 can include receiving the indication via the PLC network.

Stage 320 includes receiving, by the control unit, over a PLC network and from a power controller associated with the object, a request to determine whether to enable a provision of power from the power supply network.

Stages 310 and 320 are followed by stage 330 of determining, by the control unit, whether to allow a reception of power by the object.

Stage 330 is followed by stage 340 of sending to the power controller a power indication representative of the determination, over the PLC network.

Optionally, stage 330 is also followed by stage 350 of updating an object user database to indicate that the object that is being utilized by the user is allowed to receive power.

Method 300 can also include stage 360 of monitoring object usage by receiving information relating to a power consumption characteristic of the object. The information can be sent over the PLC network.

Method 300 can also include stage 370 of monitoring a location of the object inside a predefined premises (for example by using RFID technology).

Method 300 can also include stage 380 of responding to an exit indication the indicates that the object is about to exit a predefined premises. Stage 380 can include stage 382 of determining if the object is allowed to exit the predefined premises. Stage 380 can include stage 384 of allowing the object to receive power in an unconditional manner when the object is located outside a predefined premises and if the object is allowed to exit the predefined premises. Stage 284 can involve sending to the power controller a notification that indicates that the object can temporarily receive power in an unconditional manner, if some pre-requisites are fulfilled.

Method 300 can include applying one policy when the object is inside a predefined premises (this policy can be applied by executing stages such as stage 330) and applying another policy (this other policy can be applied by executing stage 380) when the object is outside the predefined premises. For example, the object cannot be allowed to exit the predefined premises. Yet for another example, the object can be allowed to exit the predefined premises only if one or more conditions are fulfilled. Such a condition can include an authorization to exit the predefined premises. The authorization can be issued only by predefined persons (for example, managers, object administrator, logistics department employees).

Method 300 can include at least one of the following stage or a combination thereof: (i) notifying a power controller of an object that the object is eligible to temporarily receive power in an unconditional manner if the object is located outside a predefined premises and if the object is allowed to exit the predefined premises; (ii) scheduling a temporary prevention of power to multiple objects; (iii) receiving from the power controller a status indication indicative of the status (for example-on/off) of the object; (iv) sending to the power controller a power indication representative of the determination regardless of a phase out of a multiple phase of the power supply network to which the power controller is connected.

The temporal prevention of power can be followed by receiving requests from users, thereby allowing a control unit to update the user usage database.

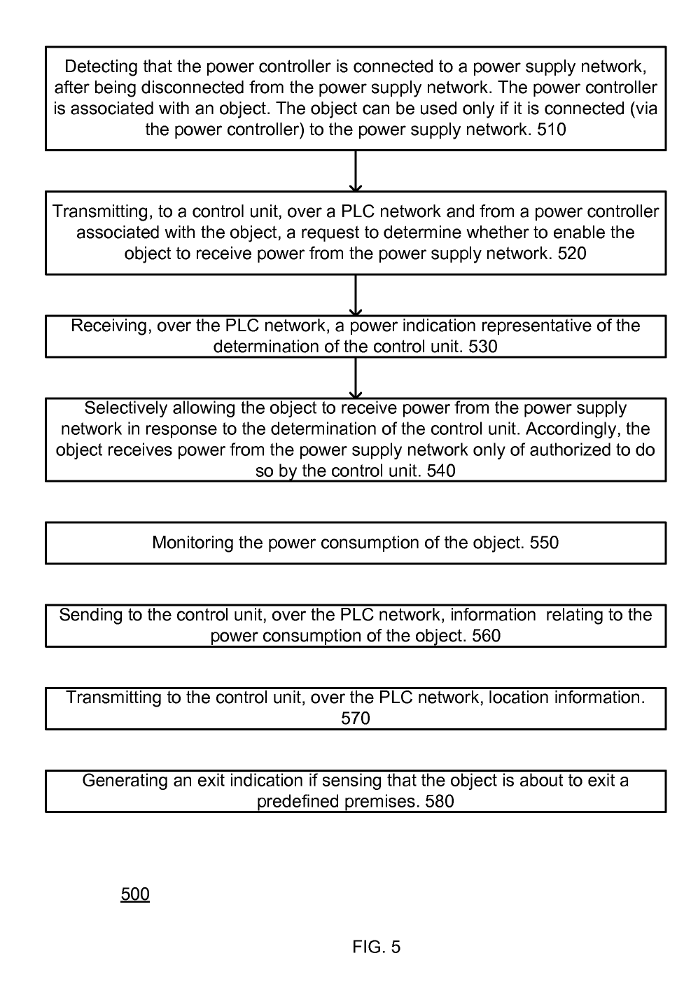

FIG. 5 illustrates method 500 for controlling a usage of objects, according to an embodiment of the invention.

Method 500 is implemented by a power controller such as any power controllers 40(1)-40(k) of FIG. 1.

Method 500 starts by stage 510 of detecting that the power controller is connected to a power supply network, after being disconnected from the power supply network. The power controller is associated with an object. The object can be used only if it is connected (via the power controller) to the power supply network.

Stage 510 is followed by stage 520 of transmitting, to a control unit, over a PLC network and from a power controller associated with the object, a request to determine whether to enable the object to receive power from the power supply network.

Stage 520 is followed by stage 530 of receiving, over the PLC network, a power indication representative of the determination of the control unit.

Stage 530 is followed by stage 540 of selectively providing power to the object in response to the determination of the control unit. Accordingly, the object received power from the power supply network only of authorized to do so by the control unit.

Method 500 can include at least one of the following optional stages or a combination thereof: (i) stage 550 of monitoring the power consumption of the object; (ii) stage 560 of sending to the control unit, over the PLC network, information relating to the power consumption of the object; (iii) stage 570 of transmitting to the control unit, over the PLC network, location information, and (iv) stage 580 of generating an exit indication if sensing that the object is about to exit a predefined premises.

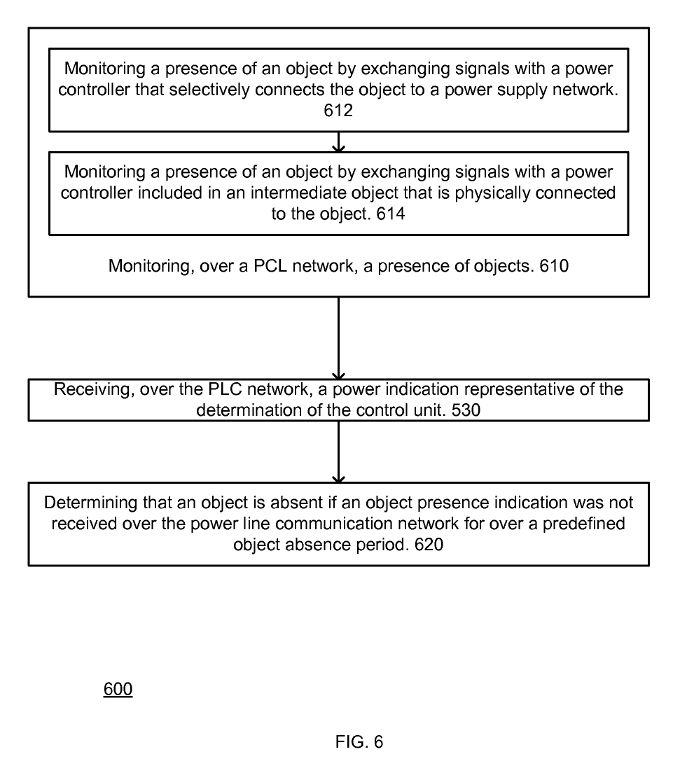

FIG. 6 illustrates method 600 detecting an absence of an object, according to an embodiment of the invention.

Method 600 starts by stage 610 of monitoring, over a PCL network, a presence of objects.

Stage 610 includes stage 612, stage 614, or a combination of both.

Stage 612 can be applied if the object should be connected to a power supply network. It includes monitoring a presence of an object by exchanging signals with a power controller that selectively connects the object to a power supply network.

Stage 614 is applied if the object should not be connected to the power supply grid. It includes monitoring a presence of an object by exchanging signals with a power controller included in an intermediate object (such as a steel cord) that is physically connected to the object. The object can be a flowerpot in which a plat is planted. The plant should be watered in regular intervals. If the flowerpot

Stage 610 is followed by stage 620 of determining that an object is absent if an object presence indication was not received over the power line communication network for over a predefined object absence period.

Stage 620 is followed by stage 630 of responding to an absence of an object. It can include generating an alert, generating an absence indication, requesting to check the object or to look for the object at the last location that the object was sensed.

The present invention can be practiced by employing conventional tools, methodology, and components. Accordingly, the details of such tools, component, and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

We claim:

1. A method for monitoring a usage of objects, the method comprises:
receiving, by a control unit, an indication that a user intends to use an object; wherein the utilization is dependent upon a reception of power from a power supply network;
receiving, by the control unit, over a power line communication network and from a power controller associated with the object, a request to determine whether to enable a provision of power from the power supply network;
determining, by the control unit, whether to allow a reception of power by the object; and
sending to the power controller a power indication representative of the determination.

2. The method according to claim 1 comprising receiving the request from a user via a network that differs from the power line communication network.

3. The method according to claim 1 comprising receiving the request from a user via an unmanned messages service unit.

4. The method according to claim 1 comprising monitoring object usage by receiving information relating to a characteristic of power consumption of the object.

5. The method according to claim 1 further comprising monitoring a location of the object inside a predefined premises.

6. The method according to claim 1 comprising responding to an exit indication the indicates that the object is about to exit a predefined premises.

7. The method according to claim 1 comprising notifying a power controller of an object that the object is eligible to temporarily receive power in an unconditional manner if the object is located outside a predefined premises and if the object is allowed to exit the predefined premises.

8. The method according to claim 1 comprising identifying the user that intends to use the object.

9. The method according to claim 1 comprising scheduling a temporary prevention of power to multiple objects.

10. The method according to claim 1 comprising receiving from the power controller a status indication indicative of the status of the object.

11. The method according to claim 1 comprising sending to the power controller a power indication representative of the determination regardless of a phase out of a multiple phase of the power supply network to which the power controller is connected.

12. A system for controlling a usage of objects, the system comprises:
a control unit that comprises:
a storage unit adapted to store an indication that a user intends to use an object; wherein the utilization is dependent upon a reception of power from a power supply network;
a power line communication receiver, adapted to receive, over a power line communication network and from a power controller associated with the object, a request to determine whether to enable a provision of power from the power supply network;
a controller, adapted to determine whether to allow a reception of power by the object; and
a power line communication transmitter, adapted to send to the power controller a power indication representative of the determination.

13. The system according to claim 9 wherein the control unit comprises a non-power line communication network receiver to receive the request from a user via a network that differs from the power line communication network.

14. The system according to claim 9 wherein the control unit is coupled to an unmanned messages service unit that is adapted to receive the request from the user.

15. The system according to claim 9 further adapted to determine object usage in response to information relating to a power consumption of the object.

16. The system according to claim 9 further adapted to receive location information and determine a location of the object inside a predefined premises.

17. The system according to claim 9 wherein the controller is adapted to respond to an exit indication that indicates that the object is about to exit a predefined premises.

18. The system according to claim 9 wherein the controller is adapted to notify a power controller of an object that the object is eligible to temporarily receive power in an unconditional manner if the object is located outside a predefined premises and if the object is allowed to exit the predefined premises.

19. The system according to claim 12 adapted to identify the user that intends to use the object.

20. The system according to claim 12 adapted to schedule a temporary prevention of power to multiple objects.

21. The system according to claim 12 adapted to receive from the power controller a status indication indicative of the status of the object.

22. The system according to claim 12 comprising sending to the power controller a power indication representative of the determination regardless of a phase out of a multiple phase of the power supply network to which the power controller is connected.
a request from a user to utilize an object; wherein the utilization is dependent upon a connection of the object to the power network;

23. A device comprising: a power controller, a relay, and power line communication transceiver;
wherein the relay is coupled between a power supply network and an object and is controlled by the power controller;
wherein the power controller controls the relay in response to a power indication that was generated by a control unit that is coupled to the power line communication transceiver over the power supply network;
wherein the power indication is sent in response to an indication that a user intends to use the object; and wherein the utilization is dependent upon a reception of power from the power supply network.

24. The device according to claim 23 wherein the power controller is integrated with a power cord.
